(19) United States
(12) Patent Application Publication
(10) Pub. No.: US 2026/0326746 A1
(43) Pub. Date: Oct. 22, 2026

(54) DISTANCE-ADAPTIVE AND USER PREFERENCE-AWARE PARKING SLOT DETECTION

(71) Applicant: GM Global Technology Operatins LLC, Detroit, MI (US)

(72) Inventors: Wei MAO, Shanghai (CN); Gabriel T. Choi, Novi, MI (US)

(21) Appl. No.: 19/189,388

(22) Filed: Apr. 25, 2025

(30) Foreign Application Priority Data
Apr. 16, 2025 (CN) 2025104837367

(51) Int. Cl. B60W 30/06; B60W 50/00; G06V 10/34; G06V 10/82; G06V 20/58

(52) U.S. Cl. CPC B60W 30/06; B60W 50/0097; G06V 10/34; G06V 10/82; G06V 20/586; B60W 2420/403; B60W 2540/215

(57) ABSTRACT

A system includes a training module and a control module. The training module is configured to receive training images, receive an actual parking slot, predict, with a model, a parking slot based on the actual parking slot and the training images, determine an association between the predicted parking slot and the actual parking slot, determine a distance-adaptive weight for the association based on a distance between a first vehicle and the actual parking slot, generate a loss between the predicted parking slot and the actual parking slot based on the distance-adaptive weight and the association, and train the model based on the loss. The control module is configured to receive one or more images external to a second vehicle, predict, with the trained model, a target parking slot based on the images, and generate a control signal for controlling the second vehicle to the target parking slot.

### CROSS-REFERENCE TO RELATED APPLICATIONS

This application claims the benefit of Chinese Patent Application No. 202510483736.7 filed on Apr. 16, 2025. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for distance-adaptive and user preference-aware parking slot detection.

A vehicle may include a vision-based parking slot detector model for detecting parking slots as the vehicle moves. For example, the vehicle may include cameras for capturing images external to the vehicle and then use the parking slot detector model to detect a parking slot, such as an available parking slot in a parking lot, based on the captured images. In such examples, the captured images may be used to generate a birds-eye view of the vehicle and its surroundings, which is then used by the parking slot detector model to detect the parking slot.

### SUMMARY

A system for distance-adaptive parking slot detection, includes a training module including a parking slot detector model. The training module is configured to receive a set of training images including at least one first parking lot, receive at least one actual parking slot in the first parking lot, predict, with the parking slot detector model, at least one parking slot in the first parking lot based on the actual parking slot and the set of training images, determine an association between the predicted parking slot and the actual parking slot, determine a distance-adaptive weight for the association based on a distance between a first vehicle and the actual parking slot, generate a loss between the predicted parking slot and the actual parking slot based on the distance-adaptive weight and the association, and train the parking slot detector model based on the loss. The system further includes a control module disposed in a second vehicle. The control module is configured to receive one or more images external to the second vehicle, the one or more images including at least one second parking lot, predict, with the trained parking slot detector model, a target parking slot in the second parking lot based on the one or more images, and generate a control signal for controlling the second vehicle to the target parking slot.

In other features, the training module is configured to generate, based on the received set of training images and the received actual parking slot in the first parking lot, a birds-eye view image having a grid of discretized tiles with a non-linear step size, and predict the at least one parking slot in the first parking lot based on the birds-eye view image having the grid of discretized tiles.

In other features, the discretized tiles increase in size as a distance from the actual parking slot increases.

In other features, the training module is configured to perturb, with Gaussian blurring, a ground truth point for the actual parking slot in the first parking lot, and determine the association between a point for the predicted parking slot and the perturbed ground truth point for the actual parking slot.

In other features, the training module is configured to perturb the ground truth point for the actual parking slot in the first parking lot by splatting the ground truth point for the actual parking slot into a Gaussian distribution centered around the ground truth point with a distance-adaptive covariance.

In other features, the training module is configured to perturb the ground truth point for the actual parking slot in the first parking lot by splatting the ground truth point for the actual parking slot into a Gaussian distribution centered around the ground truth point with a distance-fixed covariance.

In other features, the training module includes a training pipeline module in communication with the parking slot detector model. The training pipeline module is configured to receive the actual parking slot in the first parking lot, perturb, with Gaussian blurring, a ground truth point for the actual parking slot in the first parking lot, determine the association between a point for the predicted parking slot and the perturbed ground truth point for the actual parking slot, determine the distance-adaptive weight for the association based on a distance between the first vehicle and the perturbed ground truth point, generate the loss between the predicted parking slot and the actual parking slot based on the distance-adaptive weight and the association, and output the loss to the parking slot detector model.

In other features, the control module is configured to generate, based on the received images external to the second vehicle, a birds-eye view image having a grid of discretized tiles with a non-linear step size, and predict the target parking slot in the second parking lot based on the birds-eye view image having the grid of discretized tiles.

In other features, the discretized tiles increase in size as a distance from the second vehicle increases.

In other features, the control module is configured to receive a user preferred target parking slot in the second parking lot, adjust the non-linear step size for the discretized tiles based on the user preferred target parking slot, and generate the birds-eye view image having the grid of discretized tiles with the adjusted non-linear step size to increase resolution.

In other features, the discretized tiles increase in size as a distance from the user preferred target parking slot increases.

In other features, the parking slot detector model is a first parking slot detector model, and the training module is configured to train at least one second parking slot detector model.

In other features, the control module is configured to receive a user preferred target parking slot in the second parking lot, select one of the first parking slot detector model and the second parking slot detector model prior to receiving the user preferred target parking slot, and select the other one of the first parking slot detector and the second parking slot detector model in response to receiving the user preferred target parking slot.

In other features, the system further includes a vehicle control module in communication with the control module, the vehicle control module configured to control the second vehicle to move towards the target parking slot based on the control signal.

A system for distance-adaptive parking slot detection for a vehicle, includes one or more cameras configured to capture one or more images external to the vehicle, a control module in communication with the one or more cameras, and a vehicle control module in communication with the control module. The control module is configured to generate a birds-eye view image based on the one or more images, the birds-eye view image including a parking lot, receive a user preferred target parking slot in the parking lot, select, prior to receiving the user preferred target parking slot, a first trained parking slot detector model for predicting a target parking slot in the birds-eye view image, and select, in response to receiving the user preferred target parking slot, a second trained parking slot detector model for predicting a target parking slot in the birds-eye view image based on the user preferred target parking slot. The vehicle control module configured to control the vehicle to move towards the predicted target parking slot.

In other features, the control module is configured to generate the birds-eye view image having a grid of discretized tiles with a non-linear step size, and predict, with the first trained parking slot detector model, the target parking slot in the parking lot based on the birds-eye view image having the grid of discretized tiles.

In other features, the system further includes a display module in communication with the control module, the display module configured to display an image of the parking lot with the predicted target parking slot.

In other features, the discretized tiles increase in size as a distance from the vehicle increases.

In other features, the control module is configured to generate the birds-eye view image having a grid of discretized tiles with a non-linear step size, and predict, with the second trained parking slot detector model, the target parking slot in the parking lot based on the birds-eye view image having the grid of discretized tiles.

In other features, the discretized tiles increase in size as a distance from the user preferred target parking slot increases.

A method for distance-adaptive parking slot detection, includes receiving a set of training images including at least one first parking lot, receiving at least one actual parking slot in the first parking lot, predicting, with a parking slot detector model, at least one parking slot in the first parking lot based on the actual parking slot and the set of training images, determining an association between the predicted parking slot and the actual parking slot, determining a distance-adaptive weight for the association based on a distance between a first vehicle and the actual parking slot, generating a loss between the predicted parking slot and the actual parking slot based on the distance-adaptive weight and the association, training the parking slot detector model based on the loss, and implementing the trained parking slot detector model to predict a target parking slot in a second parking lot.

In other features, the method further includes generating a control signal for controlling a second vehicle to the target parking slot and controlling the second vehicle to move towards the target parking slot based on the control signal.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example training module for training one or more distance-adaptive parking slot detector (PSD) models to predict target parking slots for vehicles, according to the present disclosure;

FIG. 2 is a diagram of an example scenario showing a vehicle, a ground truth parking slot, and a predicted parking slot, according to the present disclosure;

FIG. 3 is a graph showing a covariance changing as a function of distance for perturbing a ground truth point, according to the present disclosure;

FIG. 4 is a diagram of an example scenario showing pairs of predicted marking points and ground truth points with a changing covariance, according to the present disclosure;

FIG. 5 is a graph showing a cumulative distribution function based on a distance-fixed covariance for perturbing a ground truth point, according to the present disclosure;

FIG. 6 is an example a birds-eye view image having a grid of discretized tiles with a non-linear step size, according to the present disclosure;

FIGS. 7-8 are block diagrams of an example vehicle system for distance-adaptive parking slot detection, according to the present disclosure;

FIG. 9 is a message sequence chart providing example interactions between a PSD model and modules in the vehicle system of FIGS. 7-8, according to the present disclosure;

FIG. 10 is a block diagram of an example vehicle system for distance-adaptive parking slot detection, according to the present disclosure;

FIG. 11 is a flow chart of an example process for training one or more distance-adaptive PSD models to predict target parking slots for vehicles, according to the present disclosure; and

FIG. 12 is a flow chart of an example process for implementing select distance-adaptive PSD models for parking slot detection, according to the present disclosure.

In the drawings, reference numbers may be reused to identify similar and/or identical elements.

### DETAILED DESCRIPTION

Vehicles may include vision-based parking slot detector models for detecting parking slots. For example, a vehicle may include cameras for capturing images external to the vehicle and then use a parking slot detector (PSD) model to detect parking slots in a parking lot based on the captured images. This conventional PSD model treats all parking slots equally important. In other words, the conventional vehicle PSD model treats near and far parking slots relative to the host vehicle equally important and tries to deliver the same performance for both the near and far parking slots. This equal treatment of all parking slots unnecessarily increases model sizes and computing resources, and results in inefficient use of computing resources.

The systems and methods according to the present disclosure leverage a PSD model for a vehicle that is distance-adaptive from various perspectives to detect parking slots (e.g., parking spaces). For example, and as recognized by the inventors, it is sufficient for a PSD model to increase accuracy of detecting parking slots as the vehicle approaches a target parking slot. With this distance-adaptive approach, the PSD model can shift its detection capability more to nearby parking slots without increasing model size and compute resources. In turn, the distance-adaptive PSD model provides more accurate parking slot detection in near surroundings of the vehicle and allows for faster and more accurate detection of a user's target parking slot. Additionally, if desired, the distance-adaptive approach enables the switching between small and large PSD models to utilize the limited onboard vehicle computing resource more efficiently.

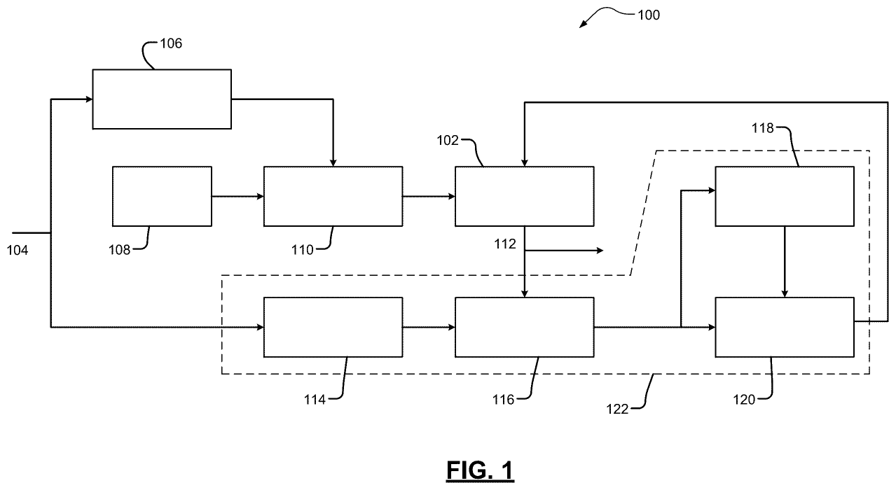

Referring now to FIG. 1, a block diagram of an example training module 100 is presented for training a distance-adaptive PSD model to predict a target parking slot for a vehicle. As shown in FIG. 1, the training module 100 generally includes a PSD model 102, a random parking slot selection module 106, a distance-adaptive image generator module 110, a distance-aware Gaussian blurring module 114, a prediction-ground truth association module 116, a distance-aware weighting module 118, and a loss generation module 120.

While the training module 100 of FIG. 1 is shown as including multiple dedicated modules 106, 110, 114, 116, 118, 120, it should be appreciated that some or all of the features provided by the modules 106, 110, 114, 116, 118, 120 may be performed by one or more modules. For instance, in some examples, the training module 100 may be a single module capable of implementing the features provided by the modules 106, 110, 114, 118, 120. Regardless, the training module may be part of or in communication with a system for distance-adaptive parking slot detection as explained herein.

In various embodiments, the training module 100 trains the PSD model 102 to be distance-adaptive from various perspectives. For example, and as further explained herein, the training module 100 can train the PSD model 102 to be distance-adaptive through a prediction-ground truth association scheme (e.g., distance-adaptive weighting, distance-aware Gaussian blurring, etc.), generation of a birds-eye view (BEV) image (or feature map) input, model architecture, etc. In such examples, the training module 100 may implement one or more of such perspectives to enable the PSD model 102 to be distance adaptive. With this approach, the PSD model 102 is trained to provide a distance-adaptive model enabling unequal treatment of parking slots, with more focus/emphasis and accuracy on closer parking slots and less focus/emphasis and accuracy on remote parking slots relative to the vehicle (e.g., an ego vehicle) and/or user provided preferences (e.g., a user preferred target parking slot or area).

In the example of FIG. 1, the training module 100 generally receives data for training the PSD model 102. For example, in FIG. 1, the training module 100 receives a set of training images 108 (or dataset representative thereof). In such examples, the set of training images 108 may include at least one parking lot. Additionally, the training module 100 receives one or more actual parking slots 104 (or dataset representative thereof) in the parking lot represented in the training images 108. In some examples, the actual parking slots 104 may be referred to as ground truth parking slots and may be randomly selected by the random parking slot selection module 106.

In various embodiments, the PSD model 102 can predict one or more parking slots 112 in the parking lot based on the actual parking slots 104 and the training images 108. The predicted parking slot(s) 112 in FIG. 1 is generally shown as an output of the PSD model 102. For example, the PSD model 102 may implement any suitable machine learning algorithm for detecting lane edges and marking points of parking slots in the parking lot and predicting the parking slots. In such examples, the machine learning algorithm may be, for example, a neural network (e.g., a convolutional neural network (CNN) or another suitable deep leaning neural network such as a transformer-based architecture, etc.) that is trainable based on the training images 108 and annotations indicating the actual parking slots 104. In various embodiment, the neural network may include various layers. For example, the neural network may include one or more input layers, one or more hidden layers, and one or more output layers. The layers may include nodes, where each node connects to another and has a weight and threshold value. If an output of a node is above its threshold value, that node may be activated, sending data to the next layer.

The training module 100 then may determine associations between the predicted parking slots from the PSD model 102 and the actual parking slots 104. For example, the prediction-ground truth association module 116 of FIG. 1 may receive the predicted parking slot(s) 112 from the PSD model 102 and the actual parking slots 104 (e.g., ground truth parking slots), and then determine associations between the predicted parking slots from the PSD model 102 and the actual parking slots 104. In such examples, the associations include relationships between the predicted parking slots and the actual parking slots, such as slot-related properties (e.g., coordinates, availabilities, etc.).

Next, the training module 100 can determine distance-adaptive weights for the associations determined by the prediction-ground truth association module 116. For example, and as shown in FIG. 1, the distance-aware weighting module 118 receives the determined associations from the prediction-ground truth association module 116 and then determines distance-adaptive weights for the associations based on a distance between a vehicle and the actual parking slots.

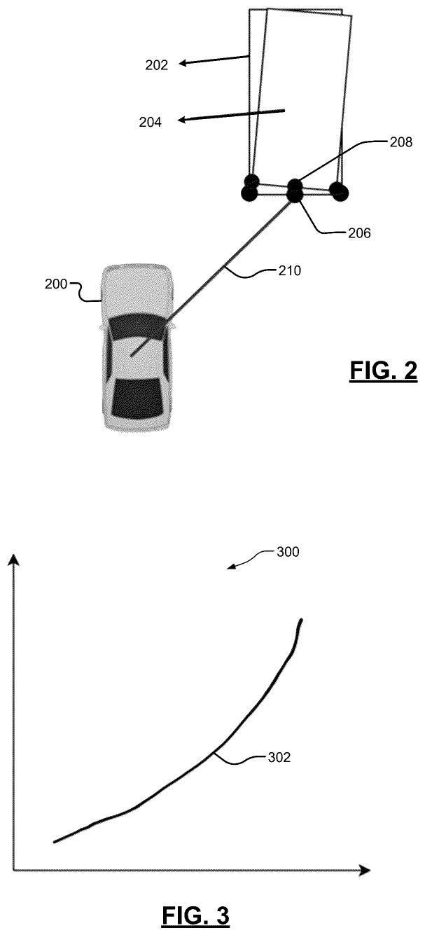

For example, FIG. 2 depicts an example scenario showing a vehicle 200, a ground truth parking slot 202 (e.g., an actual parking slot), and a predicted parking slot 204 provided by the PSD model 102. As shown, the ground truth parking slot 202 and the predicted parking slot 204 each may be defined by various points, which can be reduced to polar points. With this approach, one point can mathematically define each slot 202, 204. For example, in FIG. 2, a point 206 defines the slot 202 and a point 208 defines the slot 204. Then, a distance 210 between the vehicle 200 and the ground truth parking slot 202 (more specifically, the point 206) can be determined. In such examples, the distance 210 may be ascertained or observed based on the training images 108.

With continued reference to FIGS. 1-2, the distance-aware weighting module 118 of FIG. 1 may determine a particular distance-adaptive weight (wᵢ) based on the distance 210. In such examples, the distance-adaptive weight (wᵢ) can be used to control a loss or error based on the based on the distance 210. For example, the distance-adaptive weight (wᵢ) varies based on the distance 210. For instance, the distance-adaptive weight (wᵢ) increases (or decreases) as the distance 210 between the vehicle 200 and the ground truth parking slot 202 decreases (or increases). As such, the distance-adaptive weight (wᵢ) can effectively force the PSD model 102 to focus more on nearby parking slots (e.g., due to the reduced weight) as opposed to further away parking slots.

In various embodiments, the distance-adaptive weight (wᵢ) can also take into account user-based actions. For example, a user (e.g., a driver, etc.) may provide a selection of a preferred target parking slot or area in the parking lot. In such examples, the user selected input may be sent wirelessly to the training module 100. With this input, the distance-aware weighting module 118 may adjust the distance-adaptive weight (wᵢ) based on the user preferred target parking slot or area. In other examples, a user (e.g., a driver) may routinely park in the same parking slot or area in the parking lot. With this user action, the distance-aware weighting module 118 may also adjust the distance-adaptive weight (wᵢ) based on the user's routine action. With such approaches to adjust the distance-adaptive weight (wᵢ), the PSD model 102 can be forced to focus more on parking slots (e.g., due to the reduced weight) near the user preferred target parking slot or area and/or the routinely selected parking slot or area.

Then, the training module 100 can generate a loss between the predicted parking slots from the PSD model 102 and the actual parking slots 104 based on the distance-adaptive weights from the distance-aware weighting module 118 and the associations from the prediction-ground truth association module 116. For example, in FIG. 1, the loss generation module 120 can receive the distance-adaptive weights from the distance-aware weighting module 118 and the associations from the prediction-ground truth association module 116, and then generate a total loss (or an error) for the PSD model 102. As one example, a loss or error for the pair of slots 202, 204 of FIG. 2 (or any other pairs of slots) may be shown as Lᵢ (ŝᵢ, sᵢ) where ŝᵢ represents a predicted slot-related property (e.g. coordinate, availability, etc.) and sᵢ represents a ground truth related property. Based on this, the general total loss or error for a batch of size B can be determined according to Equation (1) below. Then, when the distance-adaptive weights are introduced, the total loss or error for the batch B can be determined according to Equation (2).

$$L = {\sum }_{i = 1}^{B} {L}_{i} ( {\hat{s}}_{i} , {s}_{i} ) \qquad Equation ( 1 )$$

$$L = {\sum }_{i = 1}^{B} {w}_{i} {L}_{i} ( {\hat{s}}_{i} , {s}_{i} ) \qquad Equation ( 2 )$$

Then, the training module 100 trains the PSD model 102 based on the generated loss. For example, and as shown in FIG. 1, the loss generation module 120 outputs the loss to the PSD model 102 as feedback. With this approach, the PSD model 102 can take into account the generated loss when predicting future parking slot(s). In such examples, this training based on the generated loss may continually occur until the PSD model 102 is sufficiently trained.

In various embodiments, the training module 100 may train the PSD model 102 to be distance-adaptive from another perspective in addition to or alternative to distance-adaptive weights explained above. For example, in some examples, the training module 100 may introduce a Gaussian blurring method to perturb the ground truth dataset according to the distances associated with N parking slots prior to the prediction-ground truth association module 116 determining the associations as explained above. This enables the associations of the predicted parking slots to ground truth parking slots to be distance aware.

For example, in FIG. 1, the distance-aware Gaussian blurring module 114 may receive the actual parking slots 104 (or the ground truth parking slots) or a representative dataset thereof. Then, the distance-aware Gaussian blurring module 114 can perturb, with Gaussian blurring, a ground truth marking point for each actual parking slot 104 (e.g., the corner of each actual parking slot 104). Once the ground truth points are perturbed, the prediction-ground truth association module 116 can determine associations between points for the predicted parking slots 112 and the perturbed ground truth points for the actual parking slots 104.

In FIG. 1, the distance-aware Gaussian blurring module 114 may implement different Gaussian blurring methods for perturbing the ground truth dataset, as further explained below. While the Gaussian blurring methods are described as being 2D Gaussian blurring methods, it should be appreciated that the Gaussian blurring methods may implemented as 3D Gaussian blurring methods if desired.

For example, the distance-aware Gaussian blurring module 114 may perturb a ground truth point for one of the actual parking slots 104 by splatting the ground truth point for the actual parking slot into a Gaussian distribution centered around the ground truth point with a distance-adaptive covariance (o). In other words, the covariance (o) or range may change or adapt based on the distance from the vehicle. For example, FIG. 3 depicts a graph 300 showing a covariance changing as a function of distance. Specifically, in FIG. 3, the graph 300 has a y-axis representing covariance (o), an x-axis representing distance, and a line 302 representing the changing covariance.

With this approach, the distance-adaptive covariance (o) creates a varying threshold to alter the ground truth dataset. As one example, FIG. 4 depicts a scenario in which three pairs 400, 402, 404 of predicted marking points and ground truth points are shown. Specifically, the pair 400 includes a ground truth point 406 and a corresponding predicted marking point 408, the pair 402 includes a ground truth point 410 and a corresponding predicted marking point 412, and the pair 404 includes a ground truth point 414 and a corresponding predicted marking point 416. As shown, a distance-adaptive covariance (o) is centered around each ground truth point 406, 410, 412, as represented by circles 420, 422, 424, respectively. More specifically, the covariance matrix in the 2D Gaussian distribution (or 3D Gaussian distribution) can be simplified to the form of Σ=σI (e.g., Equation (6) below), where I represents an identity matrix (e.g., a 2×2 matrix for 2D Gaussian distribution or a 3×3 matric for 3D Gaussian distribution) and 2 represents the covariance matrix of a multivariate gaussian distribution. With this example, o can control the spread of the Gaussian distribution.

In this example, a distance between each corresponding ground truth point and predicted marking point is the same but a distance (e.g., the distance 210 of FIG. 2) between the vehicle (e.g., the vehicle 200 of FIG. 2) and the ground truth points varies. For example, in FIG. 4, a line 418 represents a distance between the vehicle and the ground truth points 406, 410, 412. As shown, the circles 420, 422, 424 (or the covariances) are different based on the distance between the vehicle and the ground truth points 406, 410, 412. Specifically, as the distance increases (to the right side of the line 418), a particular covariance centered on a ground truth point increases.

With this approach, the distance-aware Gaussian blurring module 114 may identify a match between a ground truth point and a predicted marking point based on the distance-adaptive covariance (σ) even when the points do not overlap. For example, in FIG. 4, a match is identified when the predicted marking point lies inside a range of the distance-adaptive covariance (σ). As such, for the point pairs 400, 402, a match is not identified because the predicted marking points 408, 412 lie outside a radius (range) of the circles 420, 422. In such examples, each point pair 400, 402 may be viewed as a mismatch. However, for the point pair 404, a match is identified because the predicted marking point 416 lie inside a radius (range) of the circle 424. In other words, a stricter matching criterion is imposed on nearby parking slots. With this approach, the PSD model 102 is forced to take into account perturbed ground truth points based on distance-adaptive covariances and as a result can provide higher accuracy for the near parking slot detections.

As another example, the distance-aware Gaussian blurring module 114 may perturb a ground truth point for one of the actual parking slots 104 by splatting the ground truth point for the actual parking slot into a Gaussian distribution centered around the ground truth point with a distance-fixed covariance. With this approach, during association in the prediction-ground truth association module 116, a threshold for the Mahalanobis distance between the predicted marking points can change based on a distance between the vehicle and ground truth points. In other words, a threshold for the Mahalanobis distance can change from one predicted marking point to another predicted marking point based on a distance (e.g., the distance 210 of FIG. 2) between the vehicle (e.g., the vehicle 200 of FIG. 2) and its corresponding ground truth point.

For example, a predicted marking point (x′) may be represented by Equation (3) below and a ground truth point (x) may be represented by Equation (4) below. In this example, the predicted marking point (x′) can be assumed based on the ground truth point (x) and a fixed covariance (Σ) for a normal distribution, as shown in Equations (5)-(6) below. In this example, N represents the number of parking slots, I represents an identity matrix (as explained above), Σ represents the fixed covariance matrix of a multivariate gaussian distribution, and σ can control the spread of the Gaussian distribution. Based on the above, the Mahalanobis distance (dₘ) can be determined according to Equation (7) below. Then based on Equation (5) for the predicted marking point (x′), the Mahalanobis distance (dm) is distributed as a Chi-square distribution (DoF 2) as represented by Equation (8) below. In other words, as x′~ N(x, Σ), the Mahalanobis distance (dₘ) is distributed as a Chi-square distribution (DoF 2) as represented by Equation (8). In this example, X²(2) represents the Chi-square distribution with 2 degrees of freedom. With this approach, a stricter association means a smaller Mahalanobis distance (dₘ) and a smaller Mahalanobis distance threshold may be set for nearby (closer) parking slots.

x′=(x′₁,x′₂) Equation (3)

x=(x₁,x₂) Equation (4)

x′~N(x,Σ) Equation (5)

Σ=σI Equation (6)

dₘ(x′,x)=\sqrt{(x′−x)^{T}Σ⁻¹(x′−x)} Equation (7)

$${d}_{M}^{2} ( {x}^{′} , x ) ∼ {X}^{2} ( 2 ) \qquad Equation ( 8 )$$

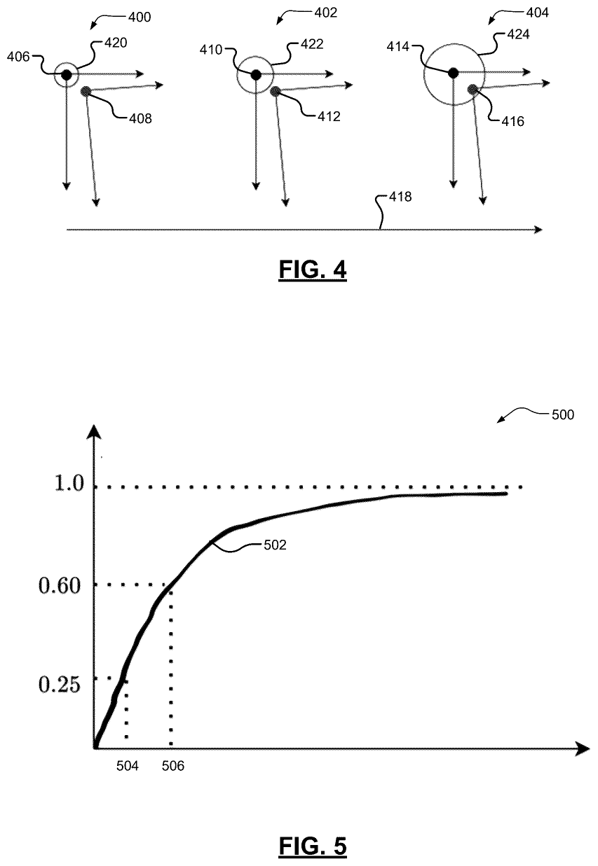

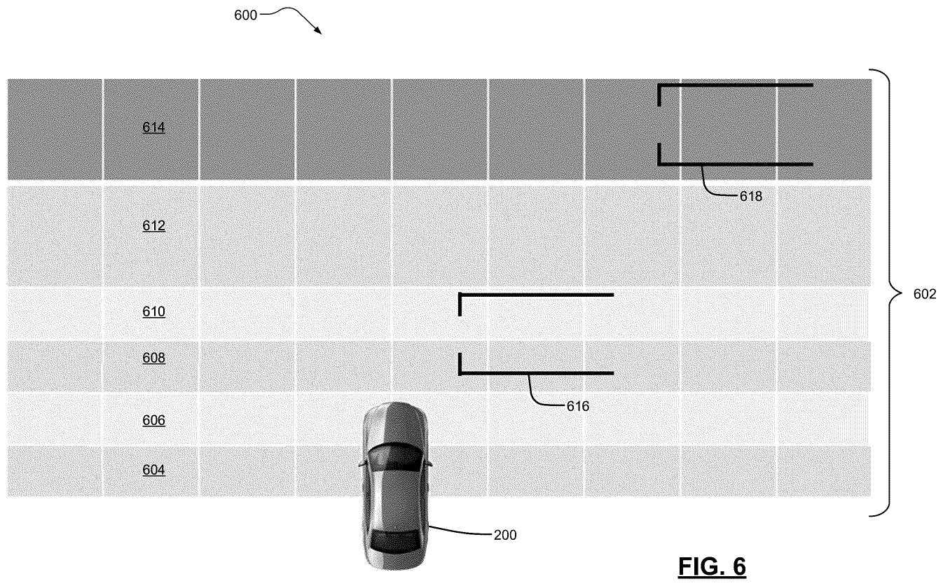

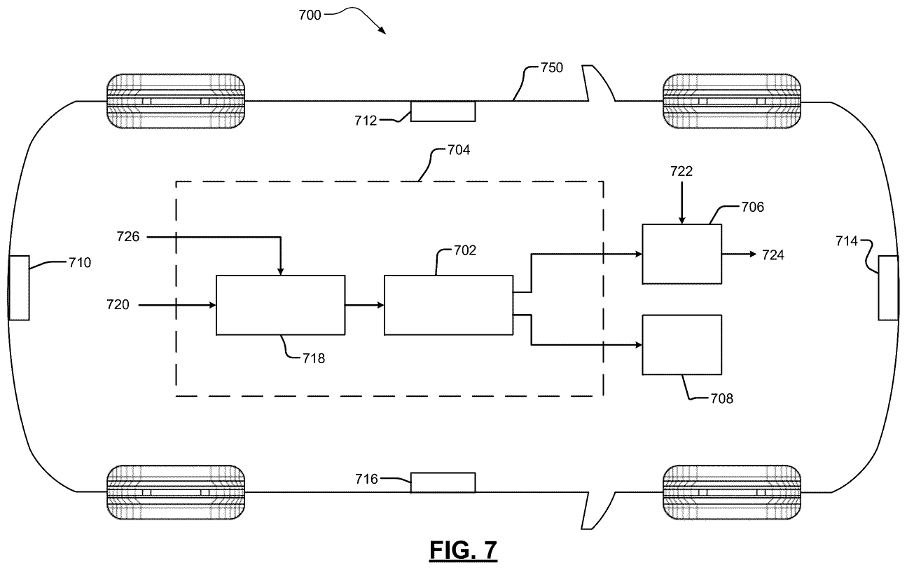

For example, FIG. 5 depicts a graph 500 showing a cumulative distribution function of Equation (8) above (e.g., the square of the Mahalanobis distance). In this example, for a more near parking slot to the vehicle, a smaller probability may be chosen to obtain a strict threshold for the Mahalanobis distance (dₘ) in Equation (7) above. Conversely, for a more remote parking slot to the vehicle, a larger probability may be chosen to obtain a looser threshold for the Mahalanobis distance (dₘ).

For example, in FIG. 5, the graph 500 has a y-axis representing a function P{dₘ<dₜₕ}, an x-axis representing a distance threshold (dₜₕ) for the Mahalanobis distance (dₘ), and a line 502 representing the cumulative distribution function. As shown, when the vehicle is near the parking slot (e.g., the distance is small), a smaller probability may be chosen (e.g., 0.25 or another example value) which correlates to a smaller threshold for the Mahalanobis distance (dₘ). This smaller threshold (a distanceₙₑₐᵣ₋ₜₕ) is represented by dashed line 504. However, when the vehicle is further from the parking slot (e.g., the distance is greater), a larger probability may be chosen (e.g., 0.6 or another example value) which correlates to larger threshold for the Mahalanobis distance (dₘ). This larger threshold (a distance_{far-th}) is represented by dashed line 506.

With continued reference to FIG. 1, the training module 100 may train the PSD model 102 to be distance-adaptive from yet another perspective in addition to or alternative to distance-adaptive weights and the distance-aware associations explained above. For example, in some examples, the training module 100 may generate an irregular gridding scheme for BEV images and/or feature maps in a distance-aware fashion. This enables the PSD model 102 to be trained on such an irregular gridding scheme with distance-aware attributes for delivering more accurate parking slot predictions.

For example, in FIG. 1, the distance-adaptive image generator module 110 receives the dataset for the training images 108 and the dataset for the actual parking slots 104 (or ground truth parking slots). In this example, the dataset for the actual parking slots 104 may be randomly selected by the random parking slot selection module 106. Then, the distance-adaptive image generator module 110 generates, based on the received datasets, a BEV image having a grid of discretized tiles with a non-linear step size. In various embodiments, the non-linear step size of the discretized tiles (e.g., cells) may be set such that the discretized tiles have a smaller step-size near the ground truth parking slot while the discretized tiles have a larger step-size in the remote area away from the ground truth parking slot. With this arrangement, the discretized tiles increase in size as a distance from the actual parking slot increases. By doing so, the PSD model 102 can be trained to deliver a more accurate position of a predicted or target parking slot.

For example, FIG. 6 depicts an example a BEV image 600 having a grid 602 of discretized tiles with a non-linear step size relative the vehicle 200. In this example, the discretized tiles are generally rectangular. In other examples, the discretized tiles may circular, triangular, or any other suitable shape.

As shown in FIG. 6, the grid 602 includes rows 604, 606, 608, 610, 612, 614 each with a set of the discretized tiles. In such examples, discretized tiles generally increase in a non-linear step size a distance increases from the vehicle 200. For example, the discretized tiles in the row 604 are smaller in size than the discretized tiles in the row 608 and the discretized tiles in the row 608 are smaller in size than the discretized tiles in the row 614.

While the discretized tiles change in size, parking slots in the BEV image 600 remain the same size, as shown by parking slots 616, 618. The parking slots 616, 618, however, are characterized by different amounts of discretized tiles. For example, the parking slot 616 closer to the vehicle 200 is defined by more discretized tiles than the parking slot 618 remote from the vehicle 200, thus providing a higher resolution focus for the parking slot 616 than the parking slot 618. With this approach, discretized tiles having a smaller step-size near the vehicle 200 or ground truth parking slot have a higher resolution input to the PSD model 102 and discretized tiles having a larger step-size remote from the vehicle 200 or ground truth parking slot have a higher resolution input to the PSD model 102. This, in turn, saves computing resources.

During training, an irregular BEV image (e.g., the BEV image 600) or BEV feature map generated by the distance-adaptive image generator module 110 can be provided to the PSD model 102 to make the model distance-adaptive. For example, and as shown in FIG. 1, the PSD model 102 receives an irregular BEV image or BEV feature map from the distance-adaptive image generator module 110 and then can predict parking slot(s) in the parking lot based on the generated irregular BEV image or BEV feature map.

In various embodiments, the training module 100 may implement a training pipeline utilizing different distance-adaptive perspectives without requiring modification of the PSD model 102. For example, and as shown in FIG. 1, the distance-aware Gaussian blurring module 114, the prediction-ground truth association module 116, the distance-aware weighting module 118, and the loss generation module 120 may be combined into a training pipeline module 122. With this arrangement, the PSD model 102 may be a plug-and-play model that may be used in different training modules without requiring modification. In such examples, the training pipeline module 122 may generally receive the dataset for the actual parking slots 104 (or ground truth parking slots), perturb, with Gaussian Blurring, ground truth points for the actual parking slots 104, determine associations between points for predicted parking slots (from the PSD model 102) and the perturbed ground truth points, determine distance-adaptive weights for the associations based on a distance between the vehicle and the perturbed ground truth points, generate a loss based on the distance-adaptive weights, and then output the loss to the PSD model 102 for training.

In various embodiments, the training module 100 may train multiple PSD models. For example, while the training module 100 is shown as including and training the PSD model 102, it should be appreciated that the training module 100 may include and/or train multiple PSD models including the PSD model 102. In such examples, the other PSD models may be trained in a similar manner as the PSD model 102 explained above. In some examples, one PSD model (e.g., the PSD model 102, etc.) may have a larger number of parameters than another PSD model. In such examples, the more parameters the PSD model has, the higher resolution BEV image or feature map it can consume for parking slot detection. As such, by using knowledge distillation, various parking slot detector of different number of parameters from a large well-performing parking slot detector can be distilled for implementation.

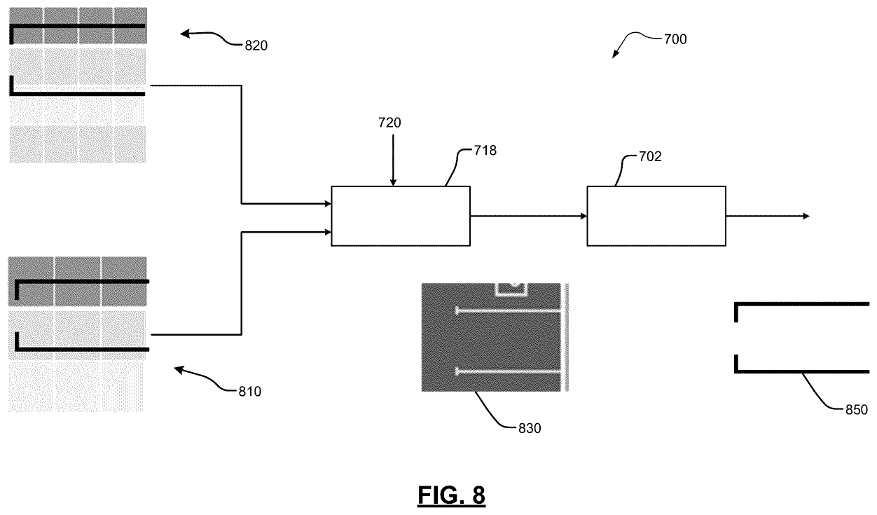

FIG. 7 depicts an example system 700 for distance-adaptive parking slot detection for a vehicle 750. As shown in FIG. 7, the system 700 (e.g., a vehicle system) generally includes a control module 704, a vehicle control module 706, a display module 708, and cameras 710, 712, 714, 716. In the example of FIG. 7, the control module 704 includes a trained PSD model 702 and a distance-adaptive image generator module 718. In various embodiments, the trained PSD model 702 may be the PSD model 102 of FIG. 1. The vehicle 750 of FIG. 7 may be any suitable vehicle, such as an autonomous vehicle, a semi-autonomous vehicle, etc. Additionally, the vehicle 750 may be an electric vehicle (e.g., a pure electric vehicle, a plug-in hybrid electric vehicle, etc.) or an internal combustion engine (ICE) vehicle.

Although FIG. 7 illustrates the system 700 as including specific dedicated modules, it should be appreciated that one or more other modules may be employed if desired. For example, any combination of the modules (e.g., the control module 704, the vehicle control module 706, the display module 708, the distance-adaptive image generator module 718, etc.) and/or the functionality thereof may be integrated into a single module or multiple different modules.

In various embodiments, the cameras 710, 712, 714, 716 can be wide-angle cameras, fish-eye cameras, etc. In other examples, the cameras 710, 712, 714, 716 may be other suitable types of sensors if desired, such as Lidar sensors, radar sensors, etc. Additionally, although FIG. 7 illustrates four specifically arranged cameras 710, 712, 714, 716, it should be appreciated that any number of cameras can be arranged on the vehicle 750.

In FIG. 7, the cameras 710, 712, 714, 716, the vehicle control module 706, and the display module 708 are in communication with the control module 704. In such examples, the modules and cameras of the system 700 may share parameters via a network, such as a controller area network (CAN) and signals. For example, in FIG. 7, the control module 704 receives signals (collectively a signal 720) representing image (or image data) from the cameras 710, 712, 714, 716.

In the example of FIG. 7, the control module 704 implements the PSD model 702 to predict a target parking slot in a parking lot. For example, in FIG. 7, the control module 704 receives one or more images (or a dataset representative thereof) external to the vehicle 750 from the cameras 710, 712, 714, 716. In such examples, the images may include a parking lot near the vehicle 750. Then, based on the received images, the PSD model 702 can predict a target parking slot in the parking lot in a similar manner as described above relative to FIG. 1. Once the target parking slot is predicted, the control module 704 can generate one or more signals, such as a control signal for controlling the vehicle 750 towards and into the target parking slot.

For example, the vehicle control module 706 may receive a signal from the control module 704 and then control the vehicle 750 towards and into the target parking slot based on the received signal and other optional input signals 722 (e.g., a lateral velocity signal, a longitudinal velocity signal, etc.). For instance, the vehicle control module 706 may generate one or more control signals 724 for controlling devices (e.g., actuators, etc.) in the vehicle 750 to move the vehicle 750 towards and into the target parking slot.

Additionally, in some examples, the display module 708 may receive a signal from the control module 704 indicative of the target parking slot. In such examples, the display module 708 may display an image of the parking lot with the target parking slot for a user (e.g., a driver, a passenger, etc.) in the vehicle 750.

In various embodiments, the control module 704 may generate an irregular gridding scheme for BEV images and/or feature maps in a distance-aware fashion, as explained relative to FIG. 1. For example, in FIG. 7, the distance-adaptive image generator module 718 receives a dataset for the external images (via the signal 720) and then generates a BEV image having a grid of discretized tiles with a non-linear step size based on the dataset. In such example, the BEV image may be similar to the BEV image 600 of FIG. 6. In the BEV image, the discretized tiles increase in size as a distance from the vehicle 750 (e.g., the vehicle 200 of FIG. 6) increases. Then, based on the BEV image, the PSD model 702 can predict the target parking slot. By doing so, when the vehicle 750 is approaching and driving (e.g. manually or autonomously) into the target parking slot, the PSD model 102 will deliver a more accurate position of the target parking slot.

In some examples, the control module 704 may receive a user selected preference represented by a signal 726 in FIG. 7. In such examples, the user selected preference may include a user preferred target parking slot or area in the parking lot. This preference may be used by the PSD model 702 when predicting predict the target parking slot.

For example, in FIG. 7, the distance-adaptive image generator module 718 receives the signal 726 indicative of a user preferred target parking slot or area. Then, based on the user preferred target parking slot or area, the distance-adaptive image generator module 718 can adjust the non-linear step size for the discretized tiles based on the user selected preference, and then generate the BEV image with the adjusted non-linear step size to increase resolution at the user selected preference. In such examples, the discretized tiles increase in size as a distance from the user selected preference increases. For instance, before the user selected preference is provided to the control module 704, the generated BEV image can employ a large step-size to detect a rough position of target parking slots for user interaction. Then, after the user selected preference is provided, the adjusted BEV image can employ a smaller step-size for the user preferred target parking slot or area to increase resolution at that slot or area. More specifically, the distance-adaptive image generator module 718 can crop out the target parking slot or area of the user selection, increase resolution, and then feed the adjusted BEV image or feature map to the PSD model 702 for higher accuracy detection of the target parking slot.

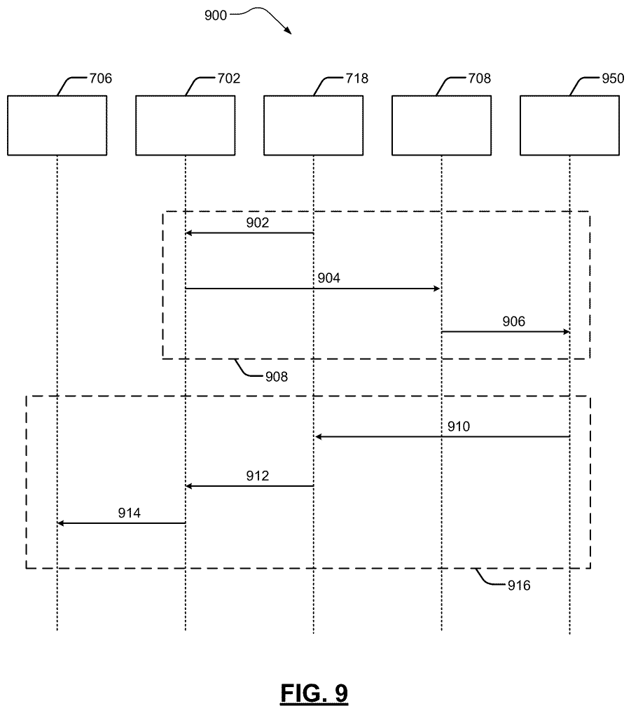

As one example, FIG. 8 depicts a portion of the system 700 including the distance-adaptive image generator module 718 and the PSD model 702. As shown, user preferred target parking slots 810, 820 and the signal 720 representing the dataset for the external images are provided to the distance-adaptive image generator module 718, which generates a BEV image 830 with a non-linear step size as explained herein. Then, based on the BEV image 830, the PSD model 702 can predict a target parking slot 850.

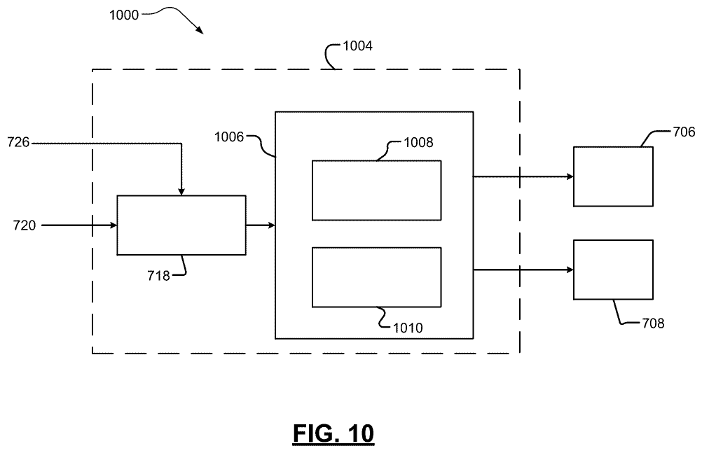

FIG. 9 depicts a message sequence chart 900 providing one example of interactions between the PSD model 702, the vehicle control module 706, the display module 708, the distance-adaptive image generator module 718 and a user 950. As shown, the interactions may be broken down into two segments 908, 916, with the segment 908 occurring prior to a user selected preference and the segment 916 occurring in response to a user selected preference.

For example, in the segment 908, the distance-adaptive image generator module 718 generates BEV image as explained herein and sends the BEV image to the PSD model 702 at 902. In this example, the generated BEV image may employ a large step-size as explained above. Then, based the generated BEV image, the PSD model 702 predicts parking slots in on a BEV image and provides the BEV image to the display module 708 at 904. In such examples, the predicted parking slots may be rough representations having decreased accuracy. The display module 708 then displays the BEV image with the predicts parking slots for the user 950 at 906.

In the segment 916, the user 950 selects a preferred target parking slot or area in the parking lot. In some examples, this selection may be made by a human-machine interface (HMI) associated with the display module 708. The preferred target parking slot or area is provided to the distance-adaptive image generator module 718 at 910. Then, the distance-adaptive image generator module 718 generates BEV image based on the preferred target parking slot or area as explained herein and sends the BEV image to the PSD model 702 at 912. In this example, the generated BEV image may employ a smaller step-size for the preferred target parking slot or area to increase resolution at that slot or area, as explained above. Next, based the generated BEV image, the PSD model 702 predicts a target parking slot and provides target parking slot (e.g., a position and attributes of the target parking slot) to the vehicle control module 706 at 914. At this point, the vehicle control module 706 can control vehicle maneuvering to move the vehicle 750 towards and into the target parking slot.

In various embodiments, the systems herein may implement a model switching scheme to select one of multiple available trained PSD models for use. In such examples, multiple PSD models may be trained (as explained above) with a different number of parameters. Then, in use, one of the trained PSD models may implemented depending on, for example, specific received inputs.

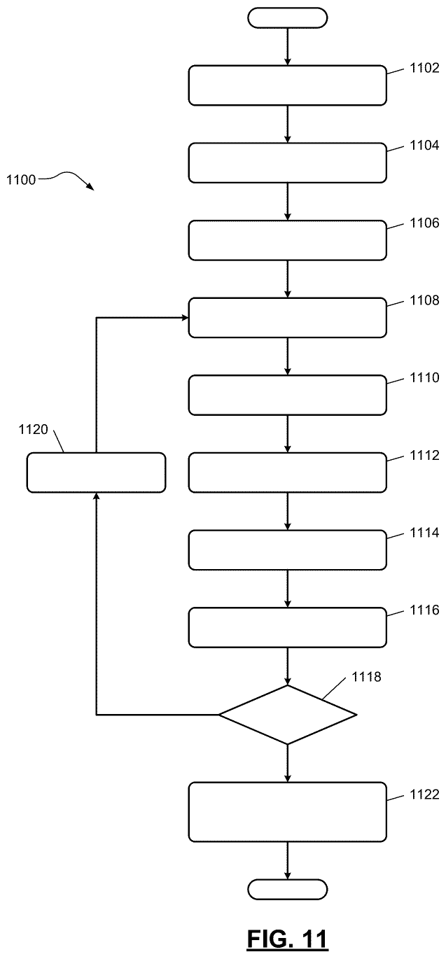

For example, FIG. 10 depicts an example system 1000 for distance-adaptive parking slot detection for a vehicle (not shown). The system 1000 (e.g., a vehicle system) is similar to the system 700 but includes a different control module. For example, in FIG. 10, the system 1000 includes a control module 1004 and the vehicle control module 706 and the display module 708 of FIG. 7. The control module 1004 includes the distance-adaptive image generator module 718 of FIG. 7 and a model selector module 1006. As explained above, the distance-adaptive image generator module 718 receives a dataset for the external images (via the signal 720) captured by the cameras 710, 712, 714, 716 in FIG. 7 and a user selected preference (via the signal 726).

In FIG. 10, the model selector module 1006 includes or has access to two trained PSD models 1008, 1010. For example, the PSD model 1008 may be a small PSD model used for offering a coarse detection of parking slots and the PSD model 1010 may be a large PSD model used for offering more accurate detection of a target parking slot. In such examples, the PSD model 1010 may have a larger number of parameters than the PSD mode 1008, as explained above. While the system 1000 of FIG. 10 is shown as including or having access to only two PSD models 1008, 1010, it should be appreciated that any number of additional PSD models may be utilized if desired.

In the example of FIG. 10, the model selector module 1006 may select one of the PSD models 1008, 1010 for use in predicting target parking slots. For example, the model selector module 1006 may select the PSD model 1008 (e.g., the small PSD model) prior to receiving the user selected preference (e.g., a user preferred target parking slot or area). In such examples, the distance-adaptive image generator module 718 can generate a BEV image employing a large step-size as explained above. Then, based on the BEV image, the PSD model 1008 can predict a course or rough target parking slot in the parking lot (e.g., near the vehicle). The display module 708 then can display an image with the target parking slot.

In other examples, the model selector module 1006 may select the PSD model 1010 (e.g., the larger PSD model) in response to receiving the user selected preference. In such examples, the distance-adaptive image generator module 718 can generate a BEV image employing a smaller step-size for the user selected preference to increase resolution, as explained above. Then, based on the BEV image, the PSD model 1010 can predict a more accurate target parking slot in the parking lot. The vehicle control module 706 then control the vehicle to move towards and into the target parking slot, as explained above.

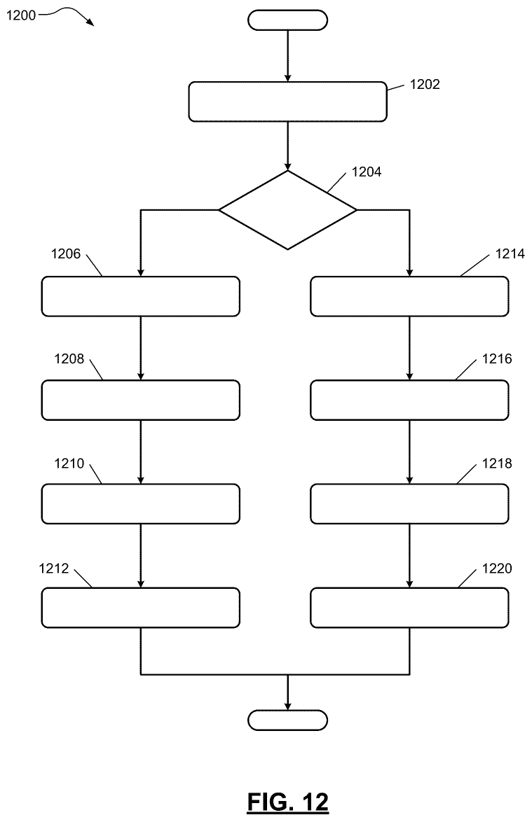

FIG. 11 illustrates example process 1100 employable by the training module 100 of FIG. 1 for training one or more distance-adaptive PSD models to predict target parking slots for vehicles. Although the example process 1100 is described in relation to the training module 100 of FIG. 1 including the PSD model 102, the process 1100 may be employable by another suitable training module for training other PSD models.

As shown in FIG. 11, the process 1100 begins by receiving a training image dataset at 1102 and receiving a ground truth dataset (e.g., actual parking slots) at 1104. The process 1100 then proceeds to 1106, where the distance-adaptive image generator module 110 generates a BEV image having a grid of discretized tiles with a non-linear step size based on the received datasets, as explained above. The process 1100 then proceeds to 1108.

At 1108, the PSD model 102 predicts parking slots in a parking lot based on the generated BEV image. The process 1100 then proceeds to 1110, where the distance-aware Gaussian blurring module 114 perturb ground truth points in the ground truth dataset as explained above. Then, at 1112, the prediction-ground truth association module 116 determines associations between the predicted parking slots from the PSD model 102 and the parking slots represented in the ground truth dataset. The process 1100 then proceeds to 1114.

At 1114, the distance-aware weighting module 118 determines distance-adaptive weights for the associations based on a distance between a vehicle and the parking slots represented in the ground truth dataset. Then, the process 1100 proceeds to 1116, where the error generation module 120 generates an error between the predicted parking slots from the PSD model 102 and the parking slots represented in the ground truth dataset based on the distance-adaptive weights.

The process 1100 then proceeds to 1118, where a determination is made as to whether the loss is less than a defined threshold. If no, model training is not done and the process 1100 proceeds to 1120 where the loss is fed back to the PSD model 102 continual training of the model 102. Otherwise, if yes at 1118, the model parameters (e.g., weights and biases) are converged during training and the process 1100 proceeds to 1122, where the PSD model 102 is implemented (e.g., quantized and deployed on a vehicle) to predict a target parking slot, as explained above. The process 1100 then ends as shown in FIG. 11 or may return to another suitable step (e.g., for training another PSD model). In the examples herein, the PSD model 102 and/or other PSD models are usually trained on graphics processing unit (GPU) server and then deployed on vehicle hardware, such as a vehicle control module. In such examples, user data may be collected and annotated, and then used to fine-tune the PSD model 102 and other PSD models if needed.

FIG. 12 illustrates example process 1200 employable by the system 1000 of FIG. 10 for distance-adaptive parking slot detection for a vehicle. Although the example process 1200 is described in relation to the system 1000 of FIG. 10, the process 1100 may be employable by another suitable vehicle system.

As shown in FIG. 12, the process 1200 begins by receiving a dataset for the external images at 1202. In such examples, the external images may be captured by the cameras 710, 712, 714, 716 of FIG. 7. The process 1200 then proceeds to 1204, where a determination is made as to whether a user selected preference (e.g., a user preferred target parking slot or area) has been received. If no, the process 1200 proceeds to 1206.

At 1206, the distance-adaptive image generator module 718 generates a BEV image having a grid of discretized tiles with a non-linear step size. In this example, the BEV image includes a large step-size arrangement as explained above. Then, at 1208, the model selector module 1006 selects the trained PSD model 1008 (e.g., a small PSD model). The process 1200 then proceeds to 1210, where the trained PSD model 1008 predicts a target parking slot based on the generated BEV image of 1206. Then, at 1212, the display module 708 displays an image with the target parking slot. The process 1200 then ends as shown in FIG. 12 or may return to another suitable step, such as 1202, 1204 if desired.

If, however, the user selected preference is received (yes at 1204), the process 1200 proceeds to 1214. At 1214, the distance-adaptive image generator module 718 generates a BEV image having a grid of discretized tiles with a non-linear step size. In this example, the BEV image includes a small step-size arrangement for the user selected preference to increase resolution, as explained above. Then, at 1216, the model selector module 1006 selects the trained PSD model 1010 (e.g., a large PSD model). The process 1200 then proceeds to 1218, where the trained PSD model 1010 predicts a target parking slot based on the generated BEV image of 1214. Then, at 1220, the vehicle control module 706 controls the vehicle to move towards and into the target parking slot, as explained above. The process 1200 then ends as shown in FIG. 12 or may return to another suitable step, such as 1202, 1204 if desired.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or J SON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for distance-adaptive parking slot detection, the system comprising:
a training module including a parking slot detector model, the training module configured to:
receive a set of training images including at least one first parking lot;
receive at least one actual parking slot in the first parking lot;
predict, with the parking slot detector model, at least one parking slot in the first parking lot based on the actual parking slot and the set of training images;
determine an association between the predicted parking slot and the actual parking slot;
determine a distance-adaptive weight for the association based on a distance between a first vehicle and the actual parking slot;
generate a loss between the predicted parking slot and the actual parking slot based on the distance-adaptive weight and the association; and
train the parking slot detector model based on the loss; and
a control module disposed in a second vehicle, the control module configured to:
receive one or more images external to the second vehicle, the one or more images including at least one second parking lot;
predict, with the trained parking slot detector model, a target parking slot in the second parking lot based on the one or more images; and
generate a control signal for controlling the second vehicle to the target parking slot.

2. The system of claim 1, wherein the training module is configured to:
generate, based on the received set of training images and the received actual parking slot in the first parking lot, a birds-eye view image having a grid of discretized tiles with a non-linear step size; and
predict the at least one parking slot in the first parking lot based on the birds-eye view image having the grid of discretized tiles.

3. The system of claim 2, wherein the discretized tiles increase in size as a distance from the actual parking slot increases.

4. The system of claim 1, wherein the training module is configured to:
perturb, with Gaussian blurring, a ground truth point for the actual parking slot in the first parking lot; and
determine the association between a point for the predicted parking slot and the perturbed ground truth point for the actual parking slot.

5. The system of claim 4, wherein the training module is configured to perturb the ground truth point for the actual parking slot in the first parking lot by splatting the ground truth point for the actual parking slot into a Gaussian distribution centered around the ground truth point with a distance-adaptive covariance.

6. The system of claim 4, wherein the training module is configured to perturb the ground truth point for the actual parking slot in the first parking lot by splatting the ground truth point for the actual parking slot into a Gaussian distribution centered around the ground truth point with a distance-fixed covariance.

7. The system of claim 1, wherein:
the training module includes a training pipeline module in communication with the parking slot detector model; and
the training pipeline module is configured to:
receive the actual parking slot in the first parking lot;
perturb, with Gaussian blurring, a ground truth point for the actual parking slot in the first parking lot;
determine the association between a point for the predicted parking slot and the perturbed ground truth point for the actual parking slot;
determine the distance-adaptive weight for the association based on a distance between the first vehicle and the perturbed ground truth point;
generate the loss between the predicted parking slot and the actual parking slot based on the distance-adaptive weight and the association; and
output the loss to the parking slot detector model.

8. The system of claim 1, wherein the control module is configured to:
generate, based on the received images external to the second vehicle, a birds-eye view image having a grid of discretized tiles with a non-linear step size; and
predict the target parking slot in the second parking lot based on the birds-eye view image having the grid of discretized tiles.

9. The system of claim 8, wherein the discretized tiles increase in size as a distance from the second vehicle increases.

10. The system of claim 8, wherein the control module is configured to:
receive a user preferred target parking slot in the second parking lot;
adjust the non-linear step size for the discretized tiles based on the user preferred target parking slot; and
generate the birds-eye view image having the grid of discretized tiles with the adjusted non-linear step size to increase resolution.

11. The system of claim 10, wherein the discretized tiles increase in size as a distance from the user preferred target parking slot increases.

12. The system of claim 10, wherein:
the parking slot detector model is a first parking slot detector model;
the training module is configured to train at least one second parking slot detector model; and
the control module is configured to:
receive a user preferred target parking slot in the second parking lot;
select one of the first parking slot detector model and the second parking slot detector model prior to receiving the user preferred target parking slot; and
select the other one of the first parking slot detector and the second parking slot detector model in response to receiving the user preferred target parking slot.

13. The system of claim 1, further comprising a vehicle control module in communication with the control module, the vehicle control module configured to control the second vehicle to move towards the target parking slot based on the control signal.

14. A system for distance-adaptive parking slot detection for a vehicle, the system comprising:
one or more cameras configured to capture one or more images external to the vehicle;
a control module in communication with the one or more cameras, the control module configured to:
generate a birds-eye view image based on the one or more images, the birds-eye view image including a parking lot;
receive a user preferred target parking slot in the parking lot;
select, prior to receiving the user preferred target parking slot, a first trained parking slot detector model for predicting a target parking slot in the birds-eye view image; and
select, in response to receiving the user preferred target parking slot, a second trained parking slot detector model for predicting a target parking slot in the birds-eye view image based on the user preferred target parking slot; and
a vehicle control module in communication with the control module, the vehicle control module configured to control the vehicle to move towards the predicted target parking slot.

15. The system of claim 14, wherein the control module is configured to:
generate the birds-eye view image having a grid of discretized tiles with a non-linear step size; and
predict, with the first trained parking slot detector model, the target parking slot in the parking lot based on the birds-eye view image having the grid of discretized tiles.

16. The system of claim 15, further comprising a display module in communication with the control module, the display module configured to display an image of the parking lot with the predicted target parking slot.

17. The system of claim 15, wherein the discretized tiles increase in size as a distance from the vehicle increases.

18. The system of claim 14, wherein:
the control module is configured to:
generate the birds-eye view image having a grid of discretized tiles with a non-linear step size, and
predict, with the second trained parking slot detector model, the target parking slot in the parking lot based on the birds-eye view image having the grid of discretized tiles; and
the discretized tiles increase in size as a distance from the user preferred target parking slot increases.

19. A method for distance-adaptive parking slot detection, the method comprising:
receiving a set of training images including at least one first parking lot;
receiving at least one actual parking slot in the first parking lot;
predicting, with a parking slot detector model, at least one parking slot in the first parking lot based on the actual parking slot and the set of training images;
determining an association between the predicted parking slot and the actual parking slot;
determining a distance-adaptive weight for the association based on a distance between a first vehicle and the actual parking slot;
generating a loss between the predicted parking slot and the actual parking slot based on the distance-adaptive weight and the association;
training the parking slot detector model based on the loss; and
implementing the trained parking slot detector model to predict a target parking slot in a second parking lot.

20. The method of claim 19, further comprising generating a control signal for controlling a second vehicle to the target parking slot and controlling the second vehicle to move towards the target parking slot based on the control signal.
